(19) United States
(12) Patent Application Publication
(10) Pub. No.: US 2018/0001228 A1
(43) Pub. Date: Jan. 4, 2018

(54) CHROMATOGRAPHIC SEPARATION OF SACCHARIDES USING WHOLE CRACKED BEADS OF GEL-TYPE STRONG ACID EXCHANGE RESIN

(71) Applicants: Dow Global Technologies LLC, Midland, MI (US); Rohm and Haas Company, Collegeville, PA (US)

(72) Inventors: Daryl J. GISCH, Midland, MI (US); Collin H. MARTIN, North Wales, PA (US); Christopher R. EICHER, Midland, MI (US)

(21) Appl. No.: 15/540,760

(22) PCT Filed: Feb. 17, 2016
(86) PCT No.: PCT/US2016/018139

§ 371 Date: Jun. 29, 2017

Related U.S. Application Data
(60) Provisional application No. 62/121,525, filed on Feb. 27, 2015.

(51) Int. Cl. B01D 15/36; C13K 1/00; B01J 39/26; C13K 11/00; B01J 39/20

(52) U.S. Cl. CPC B01D 15/362; C13K 11/00; B01J 39/20; B01J 39/26; C13K 1/00

(57) ABSTRACT

A method for chromatographically separating a first saccharide from a liquid eluent comprising the first saccharide and a second saccharide by passing the liquid eluent through a bed comprising a gel-type strong acid cation exchange resin in calcium form, wherein the resin is provided in bead form and is characterized by comprising at least 20% whole cracked beads.

### FIELD

The invention relates the use of gel-type strong acid cation exchange resins to chromatographically separate sugars including monosaccharides such as fructose and glucose.

### INTRODUCTION

The current state of the art for chromatographic separation of sugars (e.g. fructose and glucose) utilizes strong acid gel-type ion exchange resins in calcium form (Ca+²). A representative resin is DOWEX™ MONOSPHERE™ 99Ca/320 available from The Dow Chemical Company. See also U.S. Pat. No. 5,176,832. These types of chromatographic resins do not “exchange” ions in the traditional sense. Rather the bound Ca+² ions form ligand interactions with the hydroxyl (—OH) and carbonyl (C═O) groups of sugar molecules. Fructose has more “absorbing” interactions with the Ca+² ions and thus is more strongly retained by the resin as compared with glucose. Fructose with three —OH groups and two C═O groups is classified as a ketone while glucose with four —OH and one C═O groups is classified as an aldehyde. Mechanistically, the negative dipole of the C═O group interacts with the transient positive charge of the resin bound Ca+² ion. In an aqueous environment such interactions are weak and do not involve bond formation or breakage. The proximity of the two C═O groups held by fructose yield the stronger binding of the pair, resulting in a longer retention for fructose as compared to glucose. The chromatographic separation of sugars is a rate-controlled and rate-limited process. The slowest step with a typical gel resin is the “diffusion” of sugar molecules in and out of the resin bead. Slower diffusion kinetics can result from resins having larger bead sizes or non uniform “tightness” (cross-linking) Slower diffusion kinetics yield broader and lower chromatographic peaks, i.e. lower recoveries and higher water usage. For gel resins, lower cross-linking yields faster diffusion kinetics, but bead deformation in larger working beads can lead to high pressure drop and bead breakage. Similarly, smaller size gel resins yield faster diffusion kinetics, but require higher crosslinking to avoid bead breakage. Higher crosslinking levels require even higher operating pressures to load effectively.

Ion exchange resins are most commonly provided in bead form. During the manufacturing process, resin beads may become broken or cracked. Although broken beads maintain the same operating capacity as whole perfect beads, they are more prone to fluidization during backwash, and may be lost. In addition, the small fragments may fill the void spaces between the whole resin beads, resulting in increased pressure drop across the resin bed. Whole cracked beads (“WCB”) show cracks in their surface but are not broken into two or more parts. WCBs may be more prone to mechanical attrition when the resin is subjected to unusual mechanical forces, such as a crushing valve, a pump impeller or an abrasive action during the movement of resin particles from one vessel to another or within a vessel. Whole uncracked beads “WUBs” or whole perfect beads show no flaws or cracks. While all three types of beads are sometimes present together, whole cracked and broken beads are disfavored.

### SUMMARY

The invention includes a method for chromatographically separating a first saccharide from a liquid eluent including the first saccharide and a second saccharide by passing the liquid eluent through a bed including a gel-type strong acid cation exchange resin in calcium form. The resin is provided in bead form and is characterized by comprising at least 20% and more preferably at least 40% whole cracked beads.

### BRIEF DESCRIPTION OF THE DRAWINGS

FIG. 1 includes microphotographs of the resins tested in the Example section.

### DETAILED DESCRIPTION

The invention includes a method for chromatographically separating a first saccharide (analyte) from a liquid eluent including multiple saccharides, (e.g. a first and second saccharide). While the liquid eluent may include a variety of constituents, e.g. monosaccharides, disaccharides, oligosaccharides, organic acids, amino acids, inorganic salts, etc., the first and second saccharides are preferably monosaccharides (e.g. glucose and fructose). For example, in the production of high fructose corn syrup, the liquid eluent typically includes an aqueous mixture of glucose (first saccharide) and fructose (second saccharide) along with various acids and salts. As with traditional chromatographic separations of saccharides, the liquid eluent (mobile phase) passes through a bed or stratum of resin (stationary phase). The set up and operation of the bed is not particularly limited, e.g. moving, simulated moving and stationary beds may be used. Given the nature of the interactions with the resin, the first and second saccharides pass through the resin bed at different rates, thus allowing their separation. For example, fructose (second saccharide) more strongly interacts with the resin as compared with glucose (first saccharide). As a consequence, glucose passes (elutes) through the bed more quickly followed by fructose as a separate product “cut”. The individual product cuts can then be collected and used or further treated as is customary in the art.

The resin used in the present invention is a gel-type strong acid cation exchange resin in calcium form. The subject resin is provided in bead form having a median diameter from 10 to 2000 microns, and more preferably from 100 to 1000 microns. The beads may have a Gaussian particle size distribution or may have a relatively uniform particle size distribution, i.e. “monodisperse” that is, at least 90 volume percent of the beads have a particle diameter from about 0.8 to about 1.2, and more preferably 0.85 to 1.15 times the volume average particle diameter. Of the whole beads present, the subject resin includes both whole uncracked (WUB) and whole cracked beads (WCB). While the production of WCB is generally avoided by careful control over the manufacturing process, the manufacturing process may be modified to produce a high percentage of WCB, e.g. at least 20% and more preferably at least 40% of the total whole bead count. The means for producing WCB is not particularly limited and a variety of techniques are known in the art. For example, sulfonation may be conducted under conditions resulting in higher percentages of WCB. Similarly, resin beads may be subject to shrink/swell conditioning, hydrolysis, etc. to produce WCBs.

Applicable gel-type resin may be prepared according to well documented methods including the suspension polymerization at least one monovinyl aromatic monomer (e.g. styrene) and a polyvinyl aromatic crosslinking monomer (e.g. divinylbenzene) to produce a crosslinked copolymer matrix that is subsequently sulfonated and converted to calcium form. The terms “microporous,” “gellular,” “gel” and “gel-type” are synonyms that describe copolymer particles having pore sizes less than about 20 Angstroms Å. In distinction, macroporous copolymer particles have both mesopores of from about 20 Å to about 500 Å and macropores of greater than about 500 Å. Gel-type copolymer beads, as well as their preparation are described in U.S. Pat. No. 4,256,840 and U.S. Pat. No. 5,244,926. One preferred method is known in the art as a “seeded” polymerization, sometimes also referred to as batch or multi-batch (as generally described in EP 62088A1 and EP 179133A1); and continuous or semi-continuous staged polymerizations (as generally described in U.S. Pat. No. 4,419,245; U.S. Pat. No. 4,564,644; and U.S. Pat. No. 5,244,926). A seeded polymerization process typically adds monomers in two or more increments. Each increment is followed by complete or substantial polymerization of the monomers therein before adding a subsequent increment. A seeded polymerization is advantageously conducted as a suspension polymerization wherein monomers or mixtures of monomers and seed particles are dispersed and polymerized within a continuous suspending medium. In such a process, staged polymerization is readily accomplished by forming an initial suspension of monomers, wholly or partially polymerizing the monomers to form seed particles, and subsequently adding remaining monomers in one or more increments. Each increment may be added at once or continuously. Due to the insolubility of the monomers in the suspending medium and their solubility within the seed particles, the monomers are imbibed by the seed particles and polymerized therein. Multi-staged polymerization techniques can vary in the amount and type of monomers employed for each stage as well as the polymerizing conditions employed.

The seed particles employed may be prepared by known suspension polymerization techniques. In general the seed particles may be prepared by forming a suspension of a first monomer mixture in an agitated, continuous suspending medium as described by F. Helfferich in Ion Exchange, (McGraw-Hill 1962) at pp. 35-36. The first monomer mixture comprises: 1) a first monovinylidene monomer, 2) a first crosslinking monomer, and 3) an effective amount of a first free-radical initiator. The suspending medium may contain one or more suspending agents commonly employed in the art. Polymerization is initiated by heating the suspension to a temperature of generally from about 50-90° C. The suspension is maintained at such temperature or optionally increased temperatures of about 90-150° C. until reaching a desired degree of conversion of monomer to copolymer. Other suitable polymerization methods are described in U.S. Pat. No. 4,444,961; U.S. Pat. No. 4,623,706; U.S. Pat. No. 4,666,673; and U.S. Pat. No. 5,244,926—each of which is incorporated herein in its entirety.

The monovinylidene aromatic monomers employed herein are well-known and reference is made to Polymer Processes, edited by Calvin E. Schildknecht, published in 1956 by Interscience Publishers, Inc., New York, Chapter III, “Polymerization in Suspension” at pp. 69-109. Table II (pp. 78-81) of Schildknecht lists diverse types of monomers which are suitable in practicing the present invention. Of the monomers listed, styrene and substituted styrene are preferred. The term “substituted styrene” includes substituents of either/or both the vinylidene group and phenyl group of styrene and include: vinyl naphthalene, alpha alkyl substituted styrene (e.g., alpha methyl styrene) alkylene-substituted styrenes (particularly monoalkyl-substituted styrenes such as vinyltoluene and ethylvinylbenzene) and halo-substituted styrenes, such as bromo or chlorostyrene and vinylbenzyl chloride. Additional monomers may be included along with the monovinylidene aromatic monomers, including monovinylidene non-styrenics such as: esters of α,β-ethylenically unsaturated carboxylic acids, particularly acrylic or methacrylic acid, methyl methacrylate, isobornyl-methacrylate, ethylacrylate, and butadiene, ethylene, propylene, acrylonitrile, and vinyl chloride; and mixtures of one or more of said monomers. Preferred monovinylidene monomers include styrene and substituted styrene such as ethylvinylbenzene. The term “monovinylidene monomer” is intended to include homogeneous monomer mixtures and mixtures of different types of monomers, e.g. styrene and isobornylmethacrylate. The seed polymer component preferably comprises a styrenic content greater than 50 molar percent, and more preferably greater than 75, and in some embodiments greater than 95 molar percent (based upon the total molar content). The term “styrenic content” refers to the quantity of monovinylidene monomer units of styrene and/or substituted styrene utilized to form the copolymer. “Substituted styrene” includes substituents of either/or both the vinylidene group and phenyl group of styrene as described above. In preferred embodiments, the first monomer mixture used to form the first polymer component (e.g. seed) comprises at least 75 molar percent, preferably at least 85 molar percent and in some embodiments at least 95 molar percent of styrene.

Examples of suitable crosslinking monomers (i.e., polyvinylidene compounds) include polyvinylidene aromatics such as divinylbenzene, divinyltoluene, divinylxylene, divinylnaphthalene, trivinylbenzene, divinyldiphenylsulfone, as well as diverse alkylene diacrylates and alkylene dimethacrylates. Preferred crosslinking monomers are divinylbenzene, trivinylbenzene, and ethylene glycol dimethacrylate. The terms “crosslinking agent,” “crosslinker” and “crosslinking monomer” are used herein as synonyms and are intended to include both a single species of crosslinking agent along with combinations of different types of crosslinking agents. The proportion of crosslinking monomer in the copolymer seed particles is preferably sufficient to render the particles insoluble in subsequent polymerization steps (and also on conversion to an ion-exchange resin), yet still allow for adequate imbibition of an optional phase-separating diluent and monomers of the second monomer mixture. In some embodiments, no crosslinking monomer will be used. Generally, a suitable amount of crosslinking monomer in the seed particles is minor, i.e., desirably from about 0.01 to about 12 molar percent based on total moles of monomers in the first monomer mixture used to prepare the seed particles. In a preferred embodiment, the first polymer component (e.g. seed) is derived from polymerization of a first monomer mixture comprising at least 85 molar percent of styrene (or substituted styrene such as ethylvinylbenzene) and from 0.01 to about 10 molar percent of divinylbenzene.

Polymerization of the first monomer mixture may be conducted to a point short of substantially complete conversion of the monomers to copolymer or alternatively, to substantially complete conversion. If incomplete conversion is desired, the resulting partially polymerized seed particles advantageously contain a free-radical source therein capable of initiating further polymerization in subsequent polymerization stages. The term “free-radical source” refers to the presence of free-radicals, a residual amount of free-radical initiator or both, which is capable of inducing further polymerization of ethylenically unsaturated monomers. In such an embodiment of the invention, it is preferable that from about 20 to about 95 weight percent of the first monomer mixture, based on weight of the monomers therein, be converted to copolymer and more preferably from about 50 to about 90 weight percent. Due to the presence of the free radical source, the use of a free-radical initiator in a subsequent polymerization stage would be optional. For embodiments where conversion of the first monomer mixture is substantially complete, it may be necessary to use a free-radical initiator in subsequent polymerization stages.

The free-radical initiator may be any one or a combination of conventional initiators for generating free radicals in the polymerization of ethylenically unsaturated monomers. Representative initiators are UV radiation and chemical initiators, such as azo-compounds including azobisisobutyronitrile; and peroxygen compounds such as benzoyl peroxide, t-butylperoctoate, t-butylperbenzoate and isopropylpercarbonate. Other suitable initiators are mentioned in U.S. Pat. No. 4,192,921, U.S. Pat. No. 4,246,386 and U.S. Pat. No. 4,283,499—each of which is incorporated in its entirety. The free-radical initiators are employed in amounts sufficient to induce polymerization of the monomers in a particular monomer mixture. The amount will vary as those skilled in the art can appreciate and will depend generally on the type of initiators employed, as well as the type and proportion of monomers being polymerized. Generally, an amount of from about 0.02 to about 2 weight percent is adequate, based on total weight of the monomer mixture.

The first monomer mixture used to prepare the seed particles is advantageously suspended within an agitated suspending medium comprising a liquid that is substantially immiscible with the monomers, (e.g. preferably water). Generally, the suspending medium is employed in an amount from about 30 to about 70 and preferably from about 35 to about 50 weight percent based on total weight of the monomer mixture and suspending medium. Various suspending agents are conventionally employed to assist with maintaining a relatively uniform suspension of monomer droplets within the suspending medium. Illustrative suspending agents are gelatin, polyvinyl alcohol, magnesium hydroxide, hydroxyethylcellulose, methylhydroxyethyl cellulose methylcellulose and carboxymethyl methylcellulose. Other suitable suspending agents are disclosed in U.S. Pat. No. 4,419,245. The amount of suspending agent used can vary widely depending on the monomers and suspending agents employed. Latex inhibitors such as sodium dichromate may be used to minimize latex formation.

In the so-called “batch-seeded” process, seed particles comprising from about 10 to about 50 weight percent of the copolymer are preferably suspended within a continuous suspending medium. A second monomer mixture containing a free radical initiator is then added to the suspended seed particles, imbibed thereby, and then polymerized. Although less preferred, the seed particles can be imbibed with the second monomer mixture prior to being suspended in the continuous suspending medium. The second monomer mixture may be added in one amount or in stages. The second monomer mixture is preferably imbibed by the seed particles under conditions such that substantially no polymerization occurs until the mixture is substantially fully imbibed by the seed particles. The time required to substantially imbibe the monomers will vary depending on the copolymer seed composition and the monomers imbibed therein. However, the extent of imbibition can generally be determined by microscopic examination of the seed particles, or suspending media, seed particles and monomer droplets. The second monomer mixture desirably contains from about 0.5 to about 25 molar percent, preferably from about 2 to about 17 molar percent and more preferably 2.5 to about 8.5 molar percent of crosslinking monomer based on total weight of monomers in the second monomer mixture with the balance comprising a monovinylidene monomer; wherein the selection of crosslinking monomer and monovinylidene monomer are the same as those described above with reference to the preparation of the first monomer mixture, (i.e. seed preparation). As with the seed preparation, the preferred monovinylidene monomer includes styrene and/or a substituted styrene. In a preferred embodiment, the second polymer component (i.e. second monomer mixture, or “imbibed” polymer component) has a styrenic content greater than 50 molar percent, and more preferably at least 75 molar percent (based upon the total molar content of the second monomer mixture). In a preferred embodiment, the second polymer component is derived from polymerization of a second monomer mixture comprising at least 75 molar percent of styrene (and/or substituted styrene such as ethylvinylbenzene) and from about 1 to 20 molar percent divinylbenzene.

In an in-situ batch-seeded process, seed particles comprising from about 10 to about 80 weight percent of the copolymer product are initially formed by suspension polymerization of the first monomer mixture. The seed particles can have a free-radical source therein as previously described, which is capable of initiating further polymerization. Optionally, a polymerization initiator can be added with the second monomer mixture where the seed particles do not contain an adequate free radical source or where additional initiator is desired. In this embodiment, seed preparation and subsequent polymerization stages are conducted in-situ within a single reactor. A second monomer mixture is then added to the suspended seed particles, imbibed thereby, and polymerized. The second monomer mixture may be added under polymerizing conditions, but alternatively may be added to the suspending medium under conditions such that substantially no polymerization occurs until the mixture is substantially fully imbibed by the seed particles. The composition of the second monomer mixture preferably corresponds to the description previously given for the batch-seeded embodiment.

The crosslinked copolymer beads are then sulfonated, such as by methods generally described in the literature. See for example: U.S. Pat. No. 2,500,149, U.S. Pat. No. 2,631,127, U.S. Pat. No. 2,664,801, U.S. Pat. No. 2,764,564, U.S. Pat. No. 3,037,052, U.S. Pat. No. 3,266,007, U.S. Pat. No. 5,248,435, U.S. Pat. No. 5,616,622, US2002/002267 and US2004/0006145; relevant teachings of which are incorporated herein by reference. In general, sulfonated resins are prepared by reacting the copolymer matrix with a sulfonation agent, such as concentrated sulfuric acid (acid which has at least about 95 weight percent sulfuric acid based upon total weight), oleum, chlorosulfonic acid, or sulfur trioxide, at a temperature and for a time sufficient to achieve a desired degree of sulfonation. A preferred sulfonation agent is concentrated sulfuric acid. The amount of concentrated sulfuric acid should be sufficient to provide adequate mixing during reaction, with a weight ratio of acid to beads of from about 2:1 to about 20:1 being generally sufficient. Typically, the acid and copolymer beads are maintained at a temperature from about 0° C. to about 200° C. for a time sufficient to obtain resin having a dry weight capacity of at least about 0.5 milliequivalents per gram (meq/g). Sulfonation may be conducted in the presence of a swelling agent. Representative swelling agents include: methylene chloride, ethylene dichloride, dichloropropane, sulfur dioxide, benzene, toluene, xylene, ethylbenzene, isopropylbenzene, chlorobenzene, nitrobenzene, nitromethane, tetrachloroethane and tetrachloroethylene.

WCBs may be formed by varying the sulfonation conditions, e.g. acid concentration, rate of heating, mixing conditions, etc. WCBs formation may also be increased by conducting sulfonation without a swelling solvent, or by selecting a solvent which has relatively low swelling properties. WCBs may also be formed by osmotically shocking the resin through rehydrating the resin, e.g. prior to converting to the calcium form. The sulfonated resin may also be agitated, compressed or scrapped to increase WCB formation.

The sulfonated resin is subsequently converted to its calcium form using standard techniques as used with respect to ion exchange resins. For example, the sulfonated resin may be combined, agitated and soaked within a 1M solution of CaCl₂. The resin may then be optionally soaked within a saturated solution of Ca(OH)₂ followed by optionally pH adjustment, e.g. with a solution of H₃PO₄. The treatment with CaCl₂ may be repeated multiple times to ensure a high level of conversion.

The resulting resin preferably comprises at least 20% and more preferably 40% whole cracked beads, and at least 20% and more preferably at least 40% whole un-cracked beads, based upon the total whole beads present (wherein whole cracked beads and whole un-cracked beads make up the total whole bead count). When factoring in broken beads into the total bead count, whole beads preferably comprise at least 90% and more preferably at least 94% of the total bead count, wherein the total bead count=broken beads+whole beads (whole cracked and uncracked). Bead type determinations are made by visually examining a sample size of at least 200 beads using a microscope at 20× magnification. Samples may be examined by placing the sample of beads in a petri dish with sufficient water to cover the bottom of the petri dish. Whole cracked beads comprise a whole bead having either a single crack extending at least half the diameter of the bead, or at least two cracks of any length. Whole un-cracked beads comprise a whole bead with either no visual cracks, or a single crack of less than half the diameter of the bead. Broken beads comprise fragments of a whole bead and are counted by estimated their size to the nearest ⅛, ¼, ½, or ¾ of a whole bead. The fragments are then summed and rounded to the total up to the nearest whole number, e.g. 5 broken beads having the following sizes ½+¾+⅛+¾+¼=2⅜ which is rounded to 3 total broken beads.

### EXAMPLES

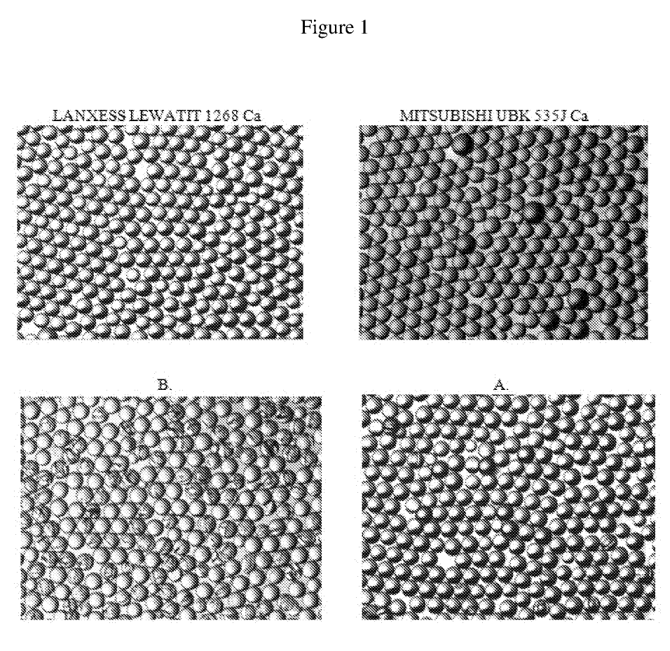

Comparative testing was conducted on two commercial resins and two experimental resins (A and B). All of the resins were strong acid (sulfonated) gel-type based upon a styrene-divinylbenzene crosslinked copolymer. All resins were tested in their calcium form. The resin samples were tested to determine their relative ability to resolve high fructose corn syrup into enriched fractions of glucose and fructose. The identity of the resins, various resin parameters and their comparative resolutions (“R”) are summarized in Table 1. Photographs for the four resins tested are provided in FIG. 1. Chromatographic testing was conducted using the following pulse testing conditions:

| | |
|---|---|
| Sugar Type | High Fructose Corn Syrup (43% fructose, |
| | 50% dissolved sugar) |
| Sugar Pulse Volume (% CV) | 11.5 |
| Flow Rate (BV/hr) | 1.1 |
| Column Temperature (C.) | 60° |
| Column Dimensions (mm) | 24.5 × 1219 |
| Total Bed Volume (mL) | 625 |
| Packing | CaCl₂ Pack |

TABLE 1

| | WRC | Total Exch. | | | Whole | Whole | Resolution |
|---|---|---|---|---|---|---|---|
| | (H+) | Capacity | VMD | | uncracked | cracked | Glu/Fru |
| Resin | (%) | (meq/ml) | (μm) | U | beads (%) | beads (%) | (BV: 1.1) |
| *Lanxess Lewatit | 60.3 | 1.60 | 281 | 1.08 | 100 | 0 | 0.3109 |
| MDS 1268 Ca 290 | | | | | | | |
| *Misubishi | 60.3 | 1.54 | 287 | 1.04 | 100 | 0 | 0.3374 |
| Dianion UBK | | | | | | | |
| 535J Ca | | | | | | | |
| *A | 57.7 | 1.70 | 280 | 1.08 | 97.7 | 2.3 | 0.3203 |
| B | 57.1 | 1.62 | 270 | 1.06 | 53.0 | 45.8 ** | 0.3609 |

*Comparison examples
** remaining beads designated as “broken” based upon the number of bead fragments counted based upon a visual inspection of at least 300 beads.
VMD = volume mean diameter,
U = Uniformity

1. A method for chromatographically separating a first saccharide from a liquid eluent comprising the first saccharide and a second saccharide by passing the liquid eluent through a bed comprising a gel-type strong acid cation exchange resin in calcium form, wherein the resin is provided in bead form and is characterized by comprising at least 20% whole cracked beads.

2. The method of claim 1 wherein the resin comprises at least 40% whole cracked beads.

3. The method of claim 1 wherein the resin comprises at least 20% whole un-cracked beads.

4. The method of claim 1 wherein the resin comprises at least 40% whole un-cracked beads.

5. The method of claim 1 wherein the first and second saccharide comprises glucose and fructose, respectively.
